(19) United States
(12) Patent Application Publication
(10) Pub. No.: US 2020/0133108 A1
(43) Pub. Date: Apr. 30, 2020

(54) LIGHT SOURCE APPARATUS AND PROJECTION-TYPE DISPLAY APPARATUS

(71) Applicant: CANON KABUSHIKI KAISHA, Tokyo (JP)

(72) Inventor: Toshiyuki Noda, Saitama-shi (JP)

(21) Appl. No.: 16/664,594

(22) Filed: Oct. 25, 2019

(30) Foreign Application Priority Data
Oct. 31, 2018 (JP) 2018-205522

(51) Int. Cl. G03B 21/16; H04N 9/31; G03B 21/14; G03B 21/20; G05D 23/19

(52) U.S. Cl. CPC G03B 21/16; H04N 9/3144; G03B 21/145; G05D 23/1932; H04N 9/3161; H04N 9/3164; G03B 21/2033

(57) ABSTRACT

An apparatus useful with or as a light source includes a first light source, a second light source configured to have an operating temperature range different from that of the first light source, a first heat receiving unit configured to receive heat from the first light source, a second heat receiving unit configured to receive heat from the second light source, and a holding member configured to hold the first light source and the second light source, wherein the first light source and the first heat receiving unit are thermally separated from the second light source and the second heat receiving unit.

### BACKGROUND

### Field

The present disclosure relates to a light source apparatus using a plurality of light sources and a projection-type display apparatus.

### Description of the Related Art

Semiconductor light emitting elements such as laser diodes (hereinbelow, also referred to as LDs) are used as light sources of projection-type display apparatuses, which can realize high durability and high luminance, and white light is generally generated by performing fluorescence conversion on light from blue LDs using a yellow fluorescent material. However, this method is inefficient because white light generated in this method is characterized in that intensity of only a predetermined wavelength is strong, and it is necessary to cut a predetermined wavelength range by an optical filter to enhance color purity. Therefore, generation of white light of which color purity is enhanced using a red LD in addition to a blue LD is considered to efficiently use light from a light source.

LDs which emit light having different wavelengths use different semiconductor materials, and thus are different in operating temperature ranges (heat resistance temperatures) and calorific values. For example, a red LD using gallium arsenide has an operating temperature range lower than that of a blue LD using gallium nitride. Therefore, in a case where different types of LDs are used at the same time, it is necessary to perform temperature control so that the LDs can be used within the respective operating temperature ranges.

Japanese Patent Application Laid-Open No. 2016-164922 discusses an example of a mechanism which performs cooling control on light sources which have different operating temperature ranges. According to Japanese Patent Application Laid-Open No. 2016-164922, the mechanism is discussed in which a heat transfer plate provided with a plurality of light sources is cooled by a Peltier element (a temperature control element), and the light sources are cooled by a common temperature control element by adjusting heat resistance by changing a contact area between the light source and the heat transfer plate.

### SUMMARY

It can be said that the configuration discussed in Japanese Patent Application Laid-Open No. 2016-164922 accomplishes a purpose by purposely hindering heat transfer to the light source having an excess cooling capacity, and wastes the cooling capacity. Therefore, wasteful power consumption is inefficient, and there is a possibility to cause noises from a cooling fan and the like.

In contrast, a configuration can be considered in which light sources having the same operating temperature range are grouped and held on a separate fixing jig for each group to efficiently cool the light sources each having different operating temperature ranges. However, such a configuration not only increases a size of an apparatus but also makes position adjustment difficult between the light sources, and thus may reduce light utilization efficiency.

In view of the above-described issues, the present disclosure features, among other things, provision of a mechanism that can accurately arrange positions between light sources and cool the light sources without wasting cooling capacity even in a case where the light sources having different operating temperature ranges are used.

According to an aspect of the present disclosure, an apparatus for cooling a first light source and a second light source, the light sources thermally separated from one another and having different operating temperature ranges includes a first heat receiving unit configured to receive heat from the first light source, a second heat receiving unit configured to receive heat from the second light source, and a holding member configured to hold the first light source and the second light source, wherein the first heat receiving unit is thermally separated from the second heat receiving unit.

Further features of the present disclosure will become apparent from the following description of exemplary embodiments with reference to the attached drawings.

### BRIEF DESCRIPTION OF THE DRAWINGS

FIG. 1 is an optical block diagram regarding a projector as a projection-type display apparatus according to an aspect of the present disclosure.

FIG. 2 illustrates a holding unit according to a first exemplary embodiment in detail.

FIG. 3A is a top view illustrating a state in which a plurality of blue laser diodes (LDs) and a plurality of red LDs are held by the holding unit thereon. FIG. 3B is a top view illustrating a state in which the plurality of blue LDs and the plurality of red LDs are removed from the holding unit.

FIG. 4 is a perspective view illustrating the holding unit in detail.

FIG. 5A is an exploded perspective view illustrating a state of a cross-section of the holding unit along a line A-A′ in FIG. 4. FIG. 5B is an exploded perspective view illustrating a state of a cross-section of the holding unit along a line B-B′ in FIG. 4.

FIG. 6A illustrates a heat radiation portion used for cooling the blue LDs illustrated in FIG. 2. FIG. 6B illustrates a heat radiation portion used for cooling the red LDs illustrated in FIG. 2.

FIG. 7 illustrates a holding unit according to a second exemplary embodiment in detail.

FIG. 8 is a block diagram illustrating a control system in a projection-type display apparatus.

FIG. 9 is a flowchart illustrating a cooling control method.

FIG. 10 illustrates a holding unit according to a third exemplary embodiment in detail.

### DESCRIPTION OF THE EMBODIMENTS

Various exemplary embodiments of the present disclosure will be described in detail below with reference to the attached drawings.

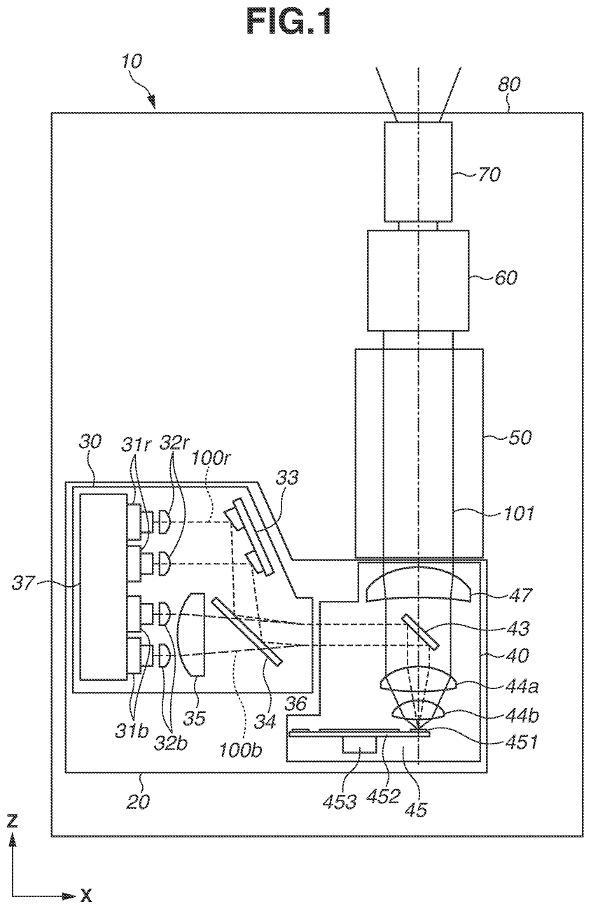

FIG. 1 illustrates an overall configuration regarding a projector as a projection-type display apparatus according to a first exemplary embodiment of the present disclosure. The present exemplary embodiment is described using a projector which uses a reflective liquid crystal display element as a light modulation element. However, the present exemplary embodiment can be applied to a projection-type display apparatus that uses two or more types of semiconductor light emitting elements having different wavelength bands. Specifically, the present exemplary embodiment can be applied to a projector that uses a light modulation element other than a reflective liquid crystal display element, for example, a digital mirror device (DMD) and a transmissive liquid crystal display element. In the following description, a right direction, an upper direction, and a paper surface direction of FIG. 1 are respectively regarded as an X axis, a Z axis, and a Y axis.

A projection-type display apparatus 10 includes a light source optical system 20, an illumination optical system 50, a color separation/combination optical system 60, a projection lens 70, and an exterior housing 80 which includes these configurations.

The light source optical system 20 is divided into a compression optical system 30 and a converging optical system 40. The compression optical system 30 includes a plurality of semiconductor light emitting elements that output light having a wavelength in a blue band, for example, blue light sources 31b as laser diodes (hereinbelow, also referred to as LDs) and a plurality of red light sources 31r that output light having a wavelength in a red band, which is different from the wavelength in the blue light source 31b. The plurality of blue light sources 31b and the plurality of red light sources 31r are arranged to be held by a holding unit 37 and to radiate heat. Holding of the LDs by the holding unit 37 and heat radiation are described in detail below.

The compression optical system 30 further includes collimator lenses 32b and 32r that are provided to correspond to each light source, a reflection mirror array 33, a first dichroic mirror 34, and a condenser lens 35. The converging optical system 40 includes a second dichroic mirror 43, a condenser lens 44a, a condenser lens 44b, a fluorescent body unit 45, and an afocal lens 47.

The plurality of blue light sources 31b and the plurality of red light sources 31r respectively oscillate an excitation light beam 100b and an excitation light beam 100r radially, and emit the excitation light beams 100b and 100r to lens components in the compression optical system 30. The reflection mirror array 33 is irradiated with the excitation light beam 100r oscillated from the red light source 31r via the collimator lens 32b.

The first dichroic mirror 34 has a characteristic in which a wavelength in the red band reflects while a wavelength other than that transmits, so that reflects again the excitation light beam 100r reflected by the reflection mirror array 33. Then, a light flux of the excitation light beam 100r emitted from each of the red light sources 31r is transmitted to the converging optical system 40.

On the other hand, the excitation light beam 100b oscillated from the blue light source 31b passes through the collimator lens 32b and the condenser lens 35, and thus a light flux of each excitation light beam 100b is compressed to be focused. The excitation light beam 100b emitted from the condenser lens 35 advances through the first dichroic mirror 34 to the converging optical system 40.

The excitation light beams 100b and 100r emitted from the compression optical system 30 advances to the second dichroic mirror 43. The second dichroic mirror 43 reflects a wavelength in the blue band and a wavelength in the red band from the excitation light beams 100b and 100r. Therefore, the excitation light beams 100b and 100r are reflected by the second dichroic mirror 43, pass through the condenser lenses 44a and 44b, and are irradiated on a fluorescent body 451 of the fluorescent body unit 45.

The fluorescent body unit 45 includes a fluorescent body wheel 452 on which the fluorescent body 451 is disposed and a motor 453 which rotates the fluorescent body wheel 452. The fluorescent body 451 is formed from a fluorescent material having a characteristic emitting fluorescent light in a yellow band when being irradiated with light having the wavelength in the blue band and a material in which a diffusion material for diffusing and reflecting excitation light is mixed in a binder. The fluorescent body 451 is disposed on a circumferential surface of the fluorescent body wheel 452, which is irradiated with the excitation light beams 100b and 100r when being rotated by the fluorescent body wheel 452.

Light obtained by mixing the fluorescent light subjected to fluorescence conversion and the excitation light beams 100b and 100r, which are not subjected to fluorescence conversion, is radiated as white light 101 to the condenser lenses 44b and 44a. Further, the white light 101 passes through the condenser lenses 44b and 44a and enters the afocal lens 47. The afocal lens 47 changes incident light to have a light flux diameter optimum to the illumination optical system 50, and causes the changed incident light to enter the illumination optical system 50.

The illumination optical system 50 includes a fly-eye lens, a polarization conversion element, and a condenser lens, which are not illustrated. Brightness of the white light 101 emitted from the afocal lens 47 is uniformized in the illumination optical system 50, and the uniformized white light 101 is emitted to the color separation/combination optical system 60 as a light flux without unevenness in color.

The color separation/combination optical system 60 includes a dichroic mirror, a polarizing beam splitter, and a reflective liquid crystal display element (hereinbelow, also referred to as a liquid crystal panel) used as a light modulation element, which are not illustrated. The white light 101 entered from the illumination optical system 50 is separated into each of green (G), blue (B), and red (R) wavelength components, and the liquid crystal panel corresponding to each wavelength is illuminated with the separated light. Each G, B, and R component light is controlled of its polarization to be reflected according to a video signal input via the liquid crystal panel. Predetermined polarized light is combined by a beam splitter for combination, then emitted to the projection lens 70, and enlarged and projected onto a projection surface such as a screen which is not illustrated.

Generally, a blue laser diode is a semiconductor light emitting element using gallium nitride (GaN), and a red laser diode is a semiconductor light emitting element using gallium arsenide (GaAs). In other words, the diodes are made from different materials. Therefore, an operating temperature range recommended for stably using the blue LD is different from an operating temperature range recommended for stably using the red LD, and an upper limit of the operating temperature range of the red LD is set lower than an upper limit of the operating temperature range of the blue LD. For example, the typical blue LD is required to be operated at 55° C. or lower, whereas the typical red LD is required to be operated at 45° C. or lower. The different types of LDs as described above are disposed on a same heat radiation member and used in the both operating temperature ranges (at the upper limit temperature or lower) by being cooled in accordance with the operating temperature range of the red LD. However, in this case, the blue LD is cooled more than necessary, and the cooling capacity is wasted, so that this configuration may cause increase in power consumption and increase in noise in a case where a cooling fan is provided. In contrast, it can be considered to divide a heat radiation member into a type of the LD. However, light emitted from the plurality of blue light sources 31b and light emitted from the plurality of red light sources 31r are used as a light flux on the same optical axis, and thus it is desirable that the LDs are held in a state in which a positional relationship with each other is accurately maintained.

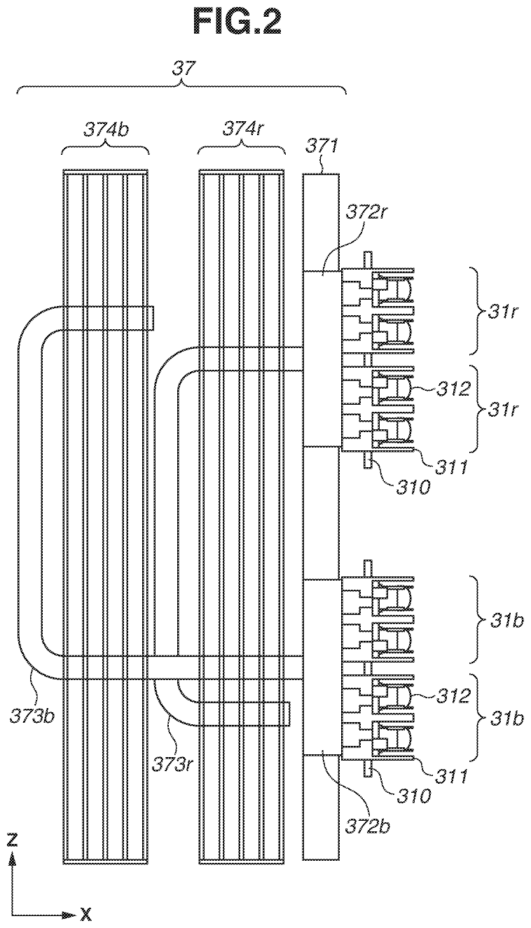

Therefore, according to the present exemplary embodiment, in order to realize both of temperature control for each type of the above-described LDs and position accuracy, the LDs having operating temperature ranges different from each other are disposed on the same holding unit 37 but are configured not to transmit heat from each other. The holding unit 37 is described in detail with reference to FIGS. 2 to 6.

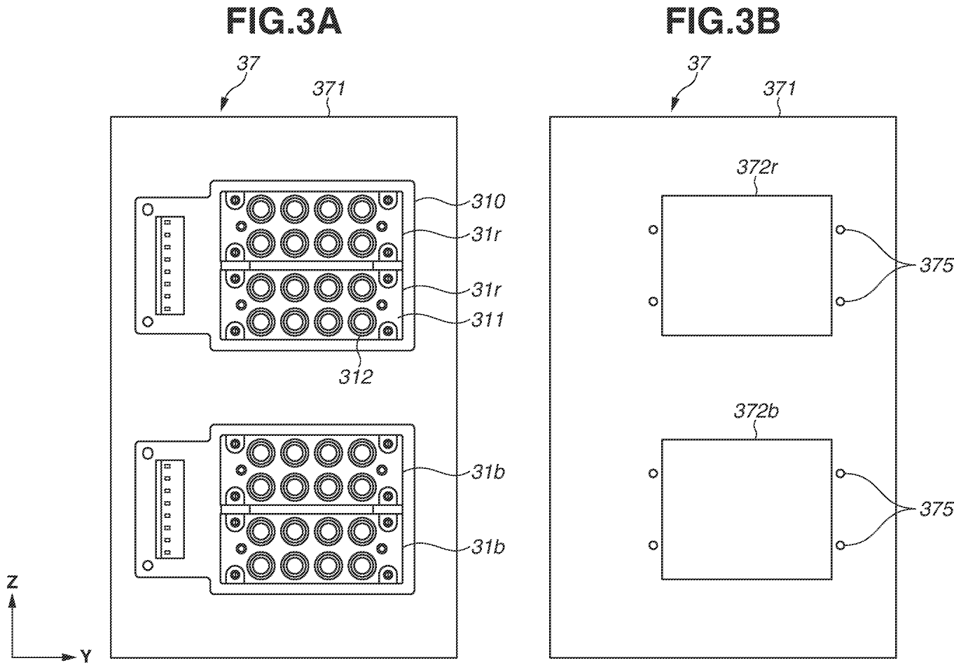

FIG. 2 is an enlarged view of the holding unit 37 viewed from a side of the Y axis in FIG. 1. FIG. 3A illustrates the holding unit 37 which holds two blue light sources 31b and two red light source 31r and is viewed from a side of the X axis in FIG. 1. FIG. 3B illustrates the holding unit 37 before the blue light source 31b and the red light source 31r in FIG. 3A are attached thereto.

The holding unit 37 includes a LD holding member 371 for holding the plurality of blue light sources 31b and the plurality of red light sources 31r, heat receiving units 372b and 372r, heat transport members 373b and 373r, projection portions 375 for positioning each of the light sources, and fins 374b and 374r.

Each of the light sources 31b and 31r is configured with a plurality of laser diodes 312 fixed by a fixing jig 311 as illustrated in FIG. 3A. Further, each of the light sources 31b and 31r is positioned by engaging the fixing jig 311 with the projection portions 375 disposed on the LD holding member 371, which is a common part and is fixed to the LD holding member 371 with a screw and the like. Each of the light sources 31b and 31r is positioned and fixed as described above and can be operated in the same process. Thus, a relative positional relationship between the light sources can be accurately arranged. Further, each of the laser diodes 312 is configured to be supplied with electricity via a printed board 310 made from a glass epoxy material and the like.

On an under side of each light source on which at least the laser diodes 312 are arranged, not the LD holding member 371 but the heat receiving units 372b and 372r are arranged as illustrated in FIG. 3B. It is desirable that the heat receiving units 372b and 372r are not affected by heat from each other, so that the heat receiving units 372b and 372r are respectively engaged with opening portions provided on the LD holding member 371 and separated from each other. Further, the heat receiving units 372b and 372r can be thermally separated from each other by forming the LD holding member 371 with a material having thermal conductivity lower than that of the material forming the heat receiving units 372b and 372r. For example, the LD holding member 371 is formed of a resin material, and the heat receiving units 372b and 372r are formed of a metal material such as aluminum, so that the heat receiving units 372b and 372r can be thermally separated from each other. In this regard, the blue light sources 31b with each other or the red light sources 31r with each other have the same operating temperature, and there is no problem to be affected by heat from each other, so that the blue light sources 31b or the red light sources 31r are arranged on the same heat receiving unit. A gap can be partially formed between the LD holding member 371 and the heat receiving units 372b and 372r to prevent heat transfer. According to the present exemplary embodiment, a state in which heat is hardly transmitted between the heat receiving units via materials of which thermal conductivity is largely different from each other is referred to as separation of heat which includes a case where some heat transfer occurs.

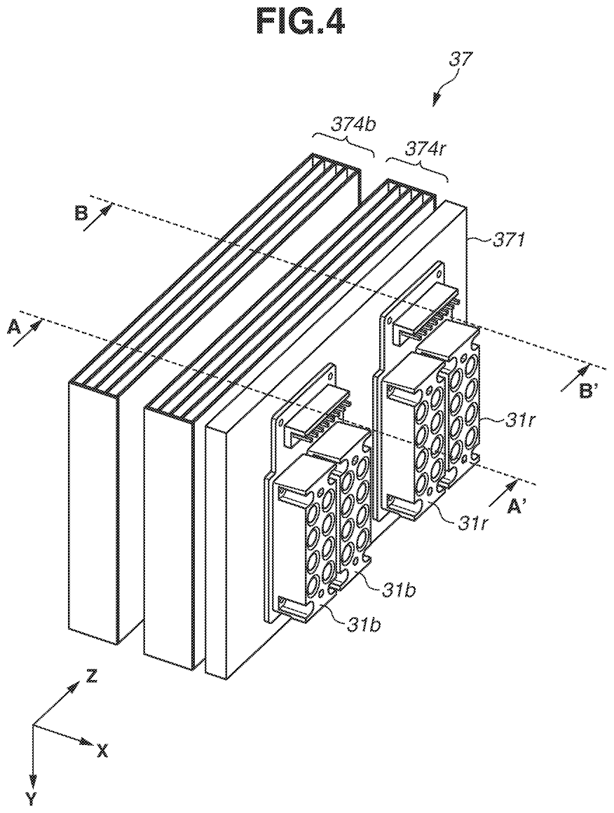

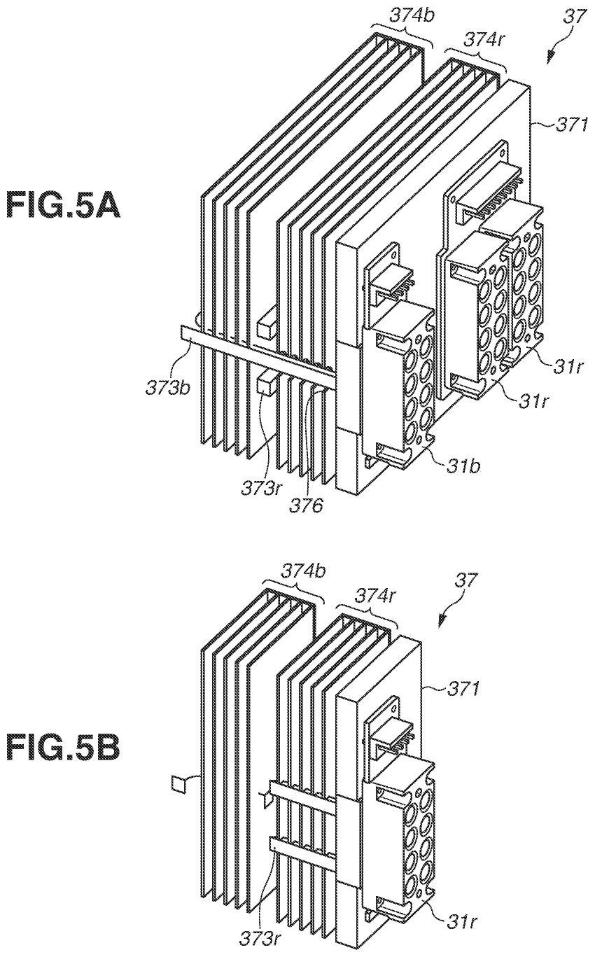

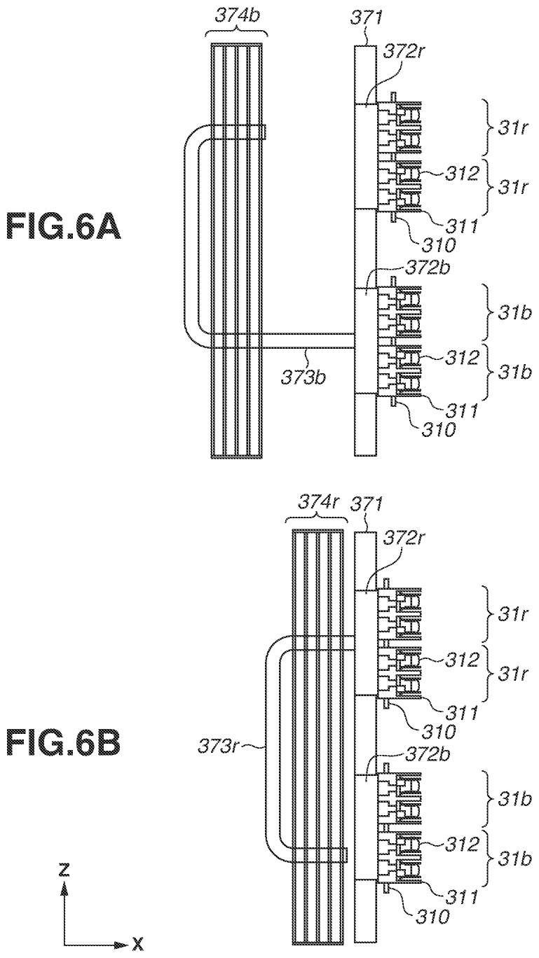

A configuration for releasing heat absorbed by the heat receiving units 372b and 372r from the respective light sources to atmosphere is described with reference to FIGS. 4 to 6. FIG. 4 is a perspective view of the holding unit 37. FIG. 5A is an exploded perspective view illustrating a cross-section of the holding unit 37 along a line A-A′ in FIG. 4. FIG. 5B is an exploded perspective view illustrating a cross-section of the holding unit 37 along a line B-B′ in FIG. 4. FIG. 6A is a drawing extracting the heat transport member 373b and a plurality of fins 374b, which are a heat radiation portion corresponding to the blue light source 31b in FIG. 2. FIG. 6B is a drawing extracting the heat transport member 373r and a plurality of fins 374r, which are a heat radiation portion corresponding to the red light source 31r in FIG. 2.

The heat receiving units 372b and 372r are thermally connected to the heat transport member such as a heat pipe made of a metal material, which is disposed to be extended from a surface opposite to a surface of the LD holding member 371 on which the blue light sources 31b and the red light sources 31r are disposed. Specifically, the heat receiving units 372b and 372r are connected by soldering, brazing, welding, and the like.

The heat transport member 373b corresponding to the heat receiving unit 372b and the heat transport member 373r corresponding to the heat receiving unit 372r are disposed by physically separated with each other to be thermally separated from each other as with the heat receiving unit. The plurality of fins (heat radiation plates) 374b and 374r made of a metal material are provided in parallel to the LD holding member 371. The plurality of fins is disposed so that the plurality of fins 374b corresponding to the blue light source 31b is not contact with the plurality of fins 374r corresponding to the red light source 31r, and is thermally separated from each other. Further, as can be seen from FIGS. 4, 5A and 5B, the plurality of fins 374b and 374r corresponding to the different types of the light sources are all arranged in parallel, so that a size of the heat radiation member can be minimized, and it can contribute to miniaturization of the apparatus.

The plurality of fins 374b corresponding to the blue light source 31b is thermally (for example, by welding) connected to the heat transport member 373b as illustrated in FIG. 5A. The plurality of fins 374r corresponding to the red light source 31r is thermally connected to the heat transport member 373r as illustrated in FIG. 5B. Further, as can be seen from FIGS. 5A and 6A, the heat transport member 373b corresponding to the blue light source 31b is joined to the heat receiving unit 372b across the plurality of fins 374r corresponding to the red light source 31r. In this regard, the heat transport member 373b is arranged not to contact with the fins 374r by passing through a hole 376 provided on the respective plurality of fins 374r. Accordingly, it can be said that the heat transport member 373b of the blue light source 31b and the plurality of fins 374r of the red light source 31r are thermally separated from each other.

According to the above-described configuration, heat generated from the blue light source 31b is transferred to the heat receiving unit 372b, further transferred to the plurality of fins 374b via the heat transport member 373b, and released to the atmosphere. Heat generated from the red light source 31r is transferred to the heat receiving unit 372r, further transferred to the plurality of fins 374r via the heat transport member 373r, and released to the atmosphere. In other words, in the blue light source 31b, the heat receiving unit 372b, the heat transport member 373b, and the plurality of fins 374b function as the heat radiation member for radiating heat to the atmosphere. In a similar way, in the red light source 31r, the heat receiving unit 372r, the heat transport member 373r, and the plurality of fins 374r function as the heat radiation member for radiating heat to the atmosphere.

In other words, according to the present exemplary embodiment, the different types of light sources are thermally separated from each other in any of “heat reception” by the heat receiving unit 372, “heat transport” by the heat transport member 373, and “heat radiation” by the plurality of fins 374. Accordingly, heat transport does not occur between the different types of light sources. Therefore, the present exemplary embodiment can individually perform temperature control on the different types of light sources, do not have to have an excess cooling capacity, and can contribute to miniaturization of the apparatus. Further, the present exemplary embodiment can prevent increase in power consumption and increase in noise caused by installation of a cooling fan. Furthermore, both of the blue light source 31b and the red light source 31r are fixed to and held by the common LD holding member 371, so that the present exemplary embodiment can hold the different types of light sources in a state in which the positional relationship with each other is accurately maintained, and can prevent reduction of light utilization efficiency.

According to the present exemplary embodiment, the configuration in which the plurality of fins 374r of the red light source 31r is arranged near the LD holding member 371 is described. However, the present exemplary embodiment can adopt a configuration in which the plurality of fins 374b of the blue light source 31b is arranged near the LD holding member 371. In this regard, however, it is necessary to cool the red light source more than the blue light source, so that it is desirable to configure heat resistance with respect to the red light source smaller than that with respect to the blue light source. Therefore, a shorter heat transport distance can make heat resistance smaller, and it can be said that it is desirable to arrange the plurality of fins 374r of the red light source 31r near the LD holding member 371.

According to the first exemplary embodiment, the example is described in which the number of fins of the red light source 31r is the same as the number of fins of the blue light source 31b (the example in which surface areas of the heat radiation members are the same). However, it is necessary to cool the red LD more than the blue LD as described above. Therefore, it is desirable to appropriately adjust a temperature during driving to be in the operating temperature range by increasing the number of fins of the red light source more than the number of fins of the blue light source to increase the surface area of the heat radiation member of the red light source more than that of the blue light source. In this case, it is necessary to differentiate the surface areas of the heat radiation members so that the heat resistance from the blue light source 31b to the atmosphere (a temperature rise quantity per calorific value per unit time) becomes the same as the heat resistance from the red light source 31r to the atmosphere.

According to the first exemplary embodiment, the structure is described in which the red light source 31r and the blue light source 31b are thermally separated from each other. As described above, the blue light source is a semiconductor light emitting element using gallium nitride (GaN), whereas the red LD is a semiconductor light emitting element using gallium arsenide (GaAs), so that the diodes are made from different materials. Therefore, the operating temperature range in which the blue LD can be used is different from the operating temperature range in which the red LD can be used, and the upper limit of the operating temperature range of the red LD is set to a lower temperature than the upper limit of the operating temperature range of the blue LD. For example, the typical blue LD is required to be operated at 55° C. or lower, whereas the typical red LD is required to be operated at 45° C. or lower. Further, light emission efficiency (an emission spectrum) depending on a temperature is different between the red LD and the blue LD. Therefore, typically the red LD and the blue LD are required not only to be thermally separated from each other but also maintained near a desired target temperature, which is to be the upper limit of the operating temperature range or lower, in order to maintain constant brightness and color balance.

Therefore, according to a second exemplary embodiment, a configuration is described in which a blowing unit such as a fan blows air to the fins in order to more accurately perform temperature control of the LDs. Descriptions of the contents same as those according to the first exemplary embodiment are omitted, and parts different from the first exemplary embodiment are mainly described.

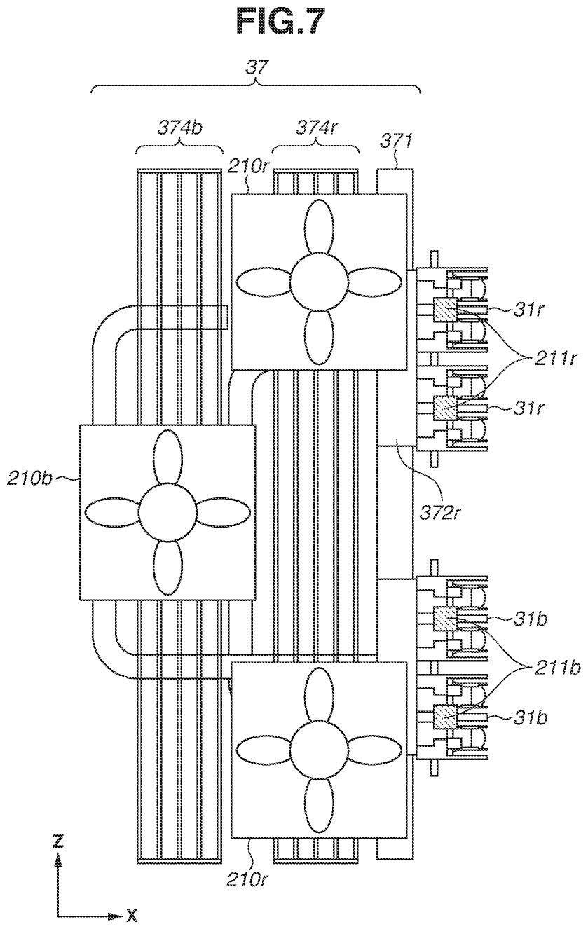

FIG. 7 is an enlarged view of the holding unit 37 according to the second exemplary embodiment viewed from the side of the Y axis in FIG. 1.

The holding unit 37 includes the LD holding member 371 for holding the plurality of blue light sources 31b and the plurality of red light sources 31r, the heat receiving units 372b and 372r, the heat transport members 373b and 373r, the projection portions 375 for positioning each of the light sources, and the fins 374b and 374r. The holding unit 37 further includes a temperature measuring element 211b (hereinbelow, referred to as a thermistor) such as a thermistor provided near each blue light source 31b to correspond to the light source and a thermistor 211r provided near each red light source 31r to correspond to the light source. According to the present exemplary embodiment, an example is described in which the thermistor is provided for each light source, but it is sufficient that the thermistor is provided at least one each for the red light source and for the blue light source.

A fan 210b (also referred to as a blowing unit) for promoting heat radiation from the fins 374b by blowing air to the fins 374b is provided on the upper side of the fins 374b corresponding to the blue light source 31b. Further, fans 210r for promoting heat radiation from the fins 374r by blowing air to the fins 374r are provided on the upper side of the fins 374r corresponding to the red light source 31r. According to the present exemplary embodiment, an example is described in which one fan 210b and two fans 210r are provided, but it is sufficient that the fan is provided at least one each for the red light source and for the blue light source. According to the present exemplary embodiment, the example is described in which the fan is provided on the upper side of the fins, but the blowing unit can be provided anywhere in the exterior housing 80 as long as the fins can be cooled by an air flow generated around the fins.

According to the above-described configuration, the blue light source 31b and the red light source 31r can be individually subjected to cooling control. In other words, a temperature when the blue light source 31b emits light is measured by the thermistor 211b, and the fan 210b is controlled to perform cooling so that the measured result becomes a desired target value (in other words, so that the operating temperature of the blue light source 31b does not exceed the upper limit value). On the other hand, a temperature when the red light source 31r emits light is measured by the thermistor 211r, and the fans 210r are controlled to perform cooling so that the measured result becomes a desired target value (in other words, so that the operating temperature of the red light source 31r does not exceed the upper limit value). Therefore, if the upper limit values of the operating temperatures of the blue light source 31b and the red light source 31r are different, the blue light source 31b and the red light source 31r can be respectively controlled at optimum temperatures.

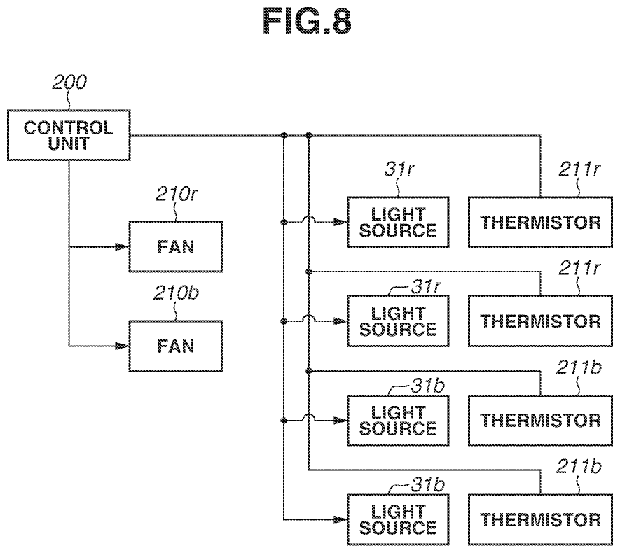

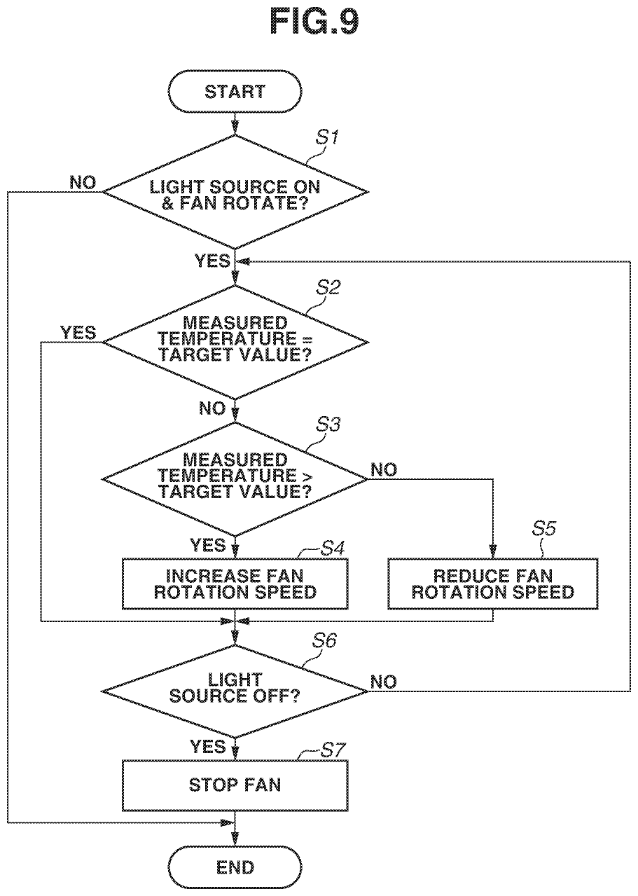

Temperature control of the light sources according to the present exemplary embodiment is described in detail with reference to FIGS. 8 and 9. FIG. 8 is a block diagram illustrating a control system in the projection-type display apparatus 10.

In a case where a user turns on the power source of the projection-type display apparatus 10, a control unit 200 supplies power to the red light source 31r and the blue light source 31b, and supplies power to drive to the fan 210r and the fan 210b as well. Further, the control unit 200 performs blowing control on the fan 210r and the fan 210b based on results of the temperature measured by the thermistor 211r and the thermistor 211b.

FIG. 9 is a flowchart illustrating a cooling control method. Processing illustrated in the flowchart in FIG. 9 is realized by the control unit 200 functioning as a control unit. The processing is separately performed on the blue light source 31b and the red light source 31r as described above. The description is made below using the blue light source 31b, but the same control is performed on the red light source 31r.

In step S1, the control unit 200 determines whether the blue light source 31b is turned on, and the fan 210b starts rotation. In a case where the fan 210b does not start rotation (NO in step S1), temperature control is not yet necessary to be performed, so that the processing is terminated. In a case where the fan 210b starts rotation (YES in step S1), the processing proceeds to step S2.

In step S2, the control unit 200 determines whether the temperature of the blue light source 31b (the temperature around the blue light source 31b) measured by the thermistor 211b is identical to the target value. In a case where the measured temperature is not identical to the target value (NO in step S2), the processing proceeds to step S3. In a case where the measured temperature is identical to the target value (YES in step S2), it is not necessary to change a rotation speed of the fan, so that the processing proceeds to step S6. The target value used in the processing is a value that is set and stored in advance, and does not exceed the upper limit value of the operating temperature. In other words, the target value is a temperature at 55° C. or lower in a case of the blue light source 31b, whereas the target value is a temperature at 45° C. or lower in a case of the red light source, and can be set to a different temperature depending on the light source. In a case where a plurality of thermistors 211 is provided, for example, an average value or a maximum value of the plurality of thermistors for each type of the light source can be used as a measured temperature.

In step S3, the control unit 200 determines whether the measured temperature is higher than the target value. In a case where the measured temperature is higher than the target value (YES in step S3), the processing proceeds to step S4, and control is performed to increase the rotation speed of the fan to increase the cooling capacity to bring the measured temperature close to the target value. On the other hand, in step S3, in a case where the measured temperature is not higher than (is lower than) the target value (NO in step S3), the processing proceeds to step S5, and control is performed to decrease the rotation speed of the fan to reduce the cooling capacity to bring the measured temperature close to the target value.

In step S6, the control unit 200 determines whether the light source is turned off. In a case where the light source is not turned off (NO in step S6), the processing returns to step S2 and is repeated. On the other hand, in a case where the light source is turned off (YES in step S6), the processing proceeds to step S7, and the fan 210b stops to cause the processing to be terminated. As described above, the processing in steps S2 to S6 is repeated during a period in which the light source is on, and thus cooling control can be performed to bring the light sources to the respective target values.

As described above, heat generated from the blue light source 31b is transferred to the heat receiving unit 372b, further transferred to the plurality of fins 374b via the heat transport member 373b, and released to the atmosphere by being blown by the fan 210b at a blow amount corresponding to the temperature of the blue light source 31b. Heat generated from the red light source 31r is transferred to the heat receiving unit 372r, further transferred to the plurality of fins 374r via the heat transport member 373r, and released to the atmosphere by being blown by the fan 210r at a blow amount corresponding to the temperature of the red light source 31r. In other words, the heat receiving unit 372b, the heat transport member 373b, and the plurality of fins 374b function as the heat radiation member for radiating heat to the atmosphere in the blue light source 31b. The heat receiving unit 372r, the heat transport member 373r, and the plurality of fins 374r function as the heat radiation member for radiating heat to the atmosphere in the red light source 31r. According to the present exemplary embodiment, the example is described in which the rotation speed is controlled based on the target value as illustrated in steps S2 and S3. However, the present control is a merely example, so that the rotation speed can be control in stages according to the measured temperature, and the target value can have an allowance.

In other words, according to the present exemplary embodiment, the different types of light sources are thermally separated from each other in any of “heat reception” by the heat receiving unit 372, “heat transport” by the heat transport member 373, and “heat radiation” by the plurality of fins 374. Further, blowing by the fan is controlled for each of the light sources, and thus cooling control can be separately performed to attain the target values of the respective light sources.

Accordingly, heat transport does not occur between the different types of light sources. Therefore, the present exemplary embodiment can individually perform temperature control on the different types of light sources, do not have to have an excess cooling capacity, and can contribute to miniaturization of the apparatus. The present exemplary embodiment can prevent increase in power consumption and increase in noise caused by installation of a cooling fan. The present exemplary embodiment do not have to have an unnecessary cooling capacity and can contribute to miniaturization of the apparatus. Further, both of the blue light source 31b and the red light source 31r are fixed to and held by the common LD holding member 371, so that the present exemplary embodiment can hold the different types of light sources in a state in which the positional relationship with each other is accurately maintained and prevent reduction of light utilization efficiency. Furthermore, the present exemplary embodiment can perform cooling control to bring the light sources to the respective target values and thus maintain brightness and color balance constant, even in a case where the light emission efficiency (the emission spectrum) depending on a temperature is different between the red LD and the blue LD.

According to the second exemplary embodiment, the example is described in which the blowing unit such as the fan is separately provided in each of the red light source 31r and the blue light source 31b, and temperature control is separately performed. According to a third exemplary embodiment, a method is described for performing cooling control corresponding to respective calorific values of the red light source 31r and the blue light source 31b while the red light source 31r and the blue light source 31b are cooled by a common fan for miniaturization of the apparatus. Descriptions of the contents same as those according to the first and the second exemplary embodiments are omitted, and parts different from the first and the second exemplary embodiments are mainly described.

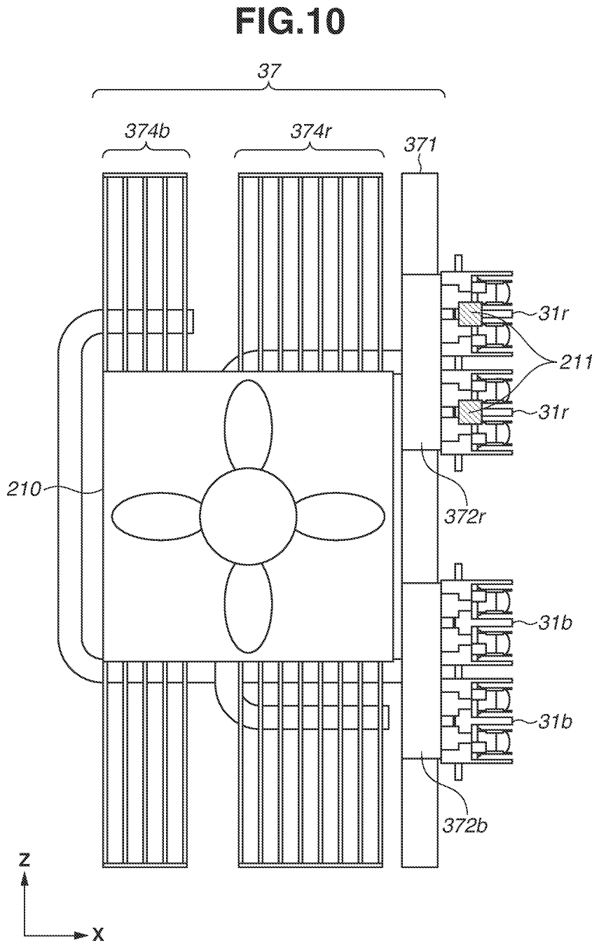

FIG. 10 is an enlarged view of the holding unit 37 according to the third exemplary embodiment viewed from the side of the Y axis in FIG. 1. As with the modification of the first exemplary embodiment, the number of the fins 374r thermally connected to the red light source 31r, which is necessary to be set to a lower target temperature, is increased more than the number of the fins 374b thermally connected to the blue light source 31b. In other words, a surface area of a heat radiation unit of the red light source 31r is increased more than a surface area of a heat radiation unit of the blue light source 31b in order to adjust heat resistance from the blue light source 31b to the atmosphere to be the same as heat resistance from the red light source 31r to the atmosphere.

In the example in FIG. 10, the thermistors 211 are provided near the red light sources 31r. However, at least one thermistor 211 may be provided in a position at which a temperature of any of the light sources can be measured. Cooling control can be performed using a flowchart similar to the flowchart in FIG. 9 according to the second exemplary embodiment. In other words, in a case where cooling control is performed using a temperature measured by the thermistor 211 corresponding to the red light source 31r, a fan 210 is to be controlled based on the target value corresponding to the red light source 31r. On the other hand, in a case where the thermistor 211 is provided in a position corresponding to the blue light source 31b, the fan 210 is to be controlled based on the target value corresponding to the blue light source 31b.

In other words, according to the present exemplary embodiment, the different types of light sources are thermally separated from each other in any of “heat reception” by the heat receiving unit 372, “heat transport” by the heat transport member 373, and “heat radiation” by the plurality of fins 374. Further, the surface area of the heat radiation unit is adjusted by taking heat resistance into consideration as described above, and thus cooling control can be performed to attain the target values of the respective light sources even if blowing is performed in common by the fan.

According to the above-described configurations, even in a case where light sources having different operating temperature ranges are used, a mechanism can be provided which can arrange the light sources with high position accuracy and can cool the light sources without wasting cooling capacity.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-205522, filed Oct. 31, 2018, which is hereby incorporated by reference herein in its entirety.

What is claimed is:

1. An apparatus for cooling a first light source and a second light source, the light sources thermally separated from one another and having different operating temperature ranges, the apparatus comprising:
a first heat receiving unit configured to receive heat from the first light source;
a second heat receiving unit configured to receive heat from the second light source; and
a holding member configured to hold the first light source and the second light source,
wherein the first heat receiving unit is thermally separated from the second heat receiving unit.

2. The apparatus according to claim 1, wherein the first heat receiving unit and the second heat receiving unit are each provided on an opening portion corresponding thereto of the holding member.

3. The apparatus according to claim 1, wherein the holding member is configured using a material having thermal conductivity lower than that of the first heat receiving unit and the second heat receiving unit.

4. The apparatus according to claim 1, wherein the first heat receiving unit and the second heat receiving unit are each thermally connected to a plurality of heat radiation plates and a heat transport member corresponding thereto.

5. The apparatus according to claim 4, wherein the plurality of heat radiation plates corresponding to the first heat receiving unit and the plurality of heat radiation plates corresponding to the second heat receiving unit are arranged in parallel.

6. The apparatus according to claim 4, wherein, in a case where the second light source is a light source whose upper limit of an operating temperature range is lower than that of the first light source, the plurality of heat radiation plates corresponding to the second heat receiving unit is arranged at a position near the holding member than the plurality of heat radiation plates corresponding to the first heat receiving unit.

7. The apparatus according to claim 4, wherein, in a case where the second light source is a light source whose upper limit of an operating temperature range is lower than that of the first light source, a surface area of the plurality of heat radiation plates corresponding to the second heat receiving unit is larger than a surface area of the plurality of heat radiation plates corresponding to the first heat receiving unit.

8. The apparatus according to claim 4, further comprising:
a first temperature measuring unit configured to measure a temperature near the first light source;
a second temperature measuring unit configured to measure a temperature near the second light source;
a blowing unit configured to blow air to the plurality of heat radiation plates corresponding to the first heat receiving unit and the plurality of heat radiation plates corresponding to the second heat receiving unit; and
a control unit configured to control the blowing unit based on results measured by the first temperature measuring unit and the second temperature measuring unit.

9. The apparatus according to claim 8,
wherein the blowing unit is provided as a first blowing unit configured to blow air to the plurality of heat radiation plates corresponding to the first heat receiving unit and a second blowing unit configured to blow air to the plurality of heat radiation plates corresponding to the second heat receiving unit, and
wherein the control unit controls the first blowing unit based on the result measured by the first temperature measuring unit and controls the second blowing unit based on the result measured by the second temperature measuring unit.

10. The apparatus according to claim 1, wherein the first light source is a light source using a blue laser diode, and the second light source is a light source using a red laser diode.

11. The apparatus according to claim 1, further comprising:
a light modulation element configured to modulate light from the light source apparatus to provide a projection type display light source.
